(19) United States
(12) Patent Application Publication
(10) Pub. No.: US 2007/0120828 A1
(43) Pub. Date: May 31, 2007

(54) Keyboard with two-stage keys for navigation

(75) Inventor: Steven H. Fyke, Waterloo (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Research In Motion Limited

(21) Appl. No.: 11/289,325

(22) Filed: Nov. 30, 2005

(51) Int. Cl. G09G 5/00

(52) U.S. Cl. 345/169

(57) ABSTRACT

A handheld electronic device has a display screen and uses a keypad as an input means. The keypad has multiple keys, at least some of which are two-stage keys such that a light touch indicates one function and a full depression indicates another function. The device is programmed so that consecutive light touches of at least two adjacent keys indicates a desired navigation function on the display screen corresponding to a direction of the consecutive light touches. An additional selection key or keys, such as a Shift, Alt or Function key or the like, may be used to vary the default navigation action indicated by the consecutive light touches.

### BACKGROUND OF THE INVENTION

This invention relates to handheld electronic devices having a display screen and using a keypad as an input means.

In such devices, navigation on the display screen is typically accomplished by such means as a 4-direction rocker switch, arrow keys, a touch pad, a touch screen, or a roller wheel. Navigation is essential in most such devices, whether to select a location to input text, to select a function, to scroll down through items displayed, or for other reasons.

An alternative means of navigating would be desirable in some situations, to avoid the need to use any of the preceding navigation means.

### BRIEF DESCRIPTION OF THE DRAWINGS

Embodiments of the invention will now be described, by way of example only, with reference to the attached drawings, in which:

FIG. 1 is a front view of an exemplary handheld device;

FIG. 2 is a perspective view, showing a user dragging a finger “down” on the keypad;

FIG. 3 is a schematic cross-section at A-A of FIG. 1; and

FIG. 4 is a flowchart illustrating the logic of an exemplary embodiment.

### DETAILED DESCRIPTION OF THE INVENTION

The invention is defined by the accompanying claims.

Details of certain aspects of the invention, and non-limiting examples of the invention, will be provided in the following detailed description. In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

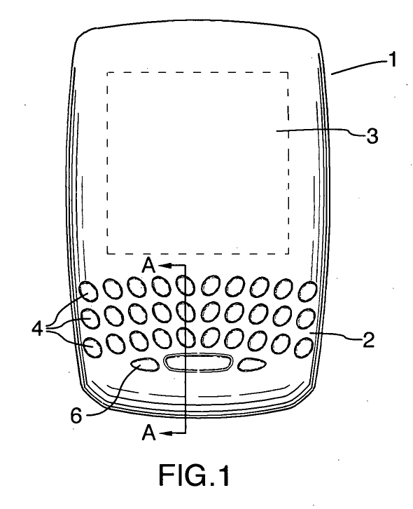

A preferred or exemplary embodiment is illustrated in FIGS. 1-4. FIG. 1 shows a typical device 1 with a keypad 2 and a display 3. Obviously, the invention is not limited to this particular device, keypad or display, nor to the particular keypad layout.

The keypad has a number of keys 4. At least some of the keys, or preferably most or all of the keys, are in effect two-stage switches. When depressed fully (to their second stage), the keys provide their normal expected function. For example, pressing the Z key might input the letter Z into a document or message on the display. However, a very light touch of a key, produced for example by the user lightly dragging his or her finger across the key, would be sufficient to trigger the key to its first stage. Typically but not necessarily, that first stage has no tactile “click” or the like as feedback to the user. By sensing sequential first stage triggering of keys in a particular direction, the device can determine a direction in which the user wishes to navigate on the screen.

Two-stage switches of the general type are commonly used in cameras. The first stage calculates exposure and/or focus, and the second stage triggers the image capture. Here, the first stage can provide navigation input, while the second stage provides the “normal” function for the key.

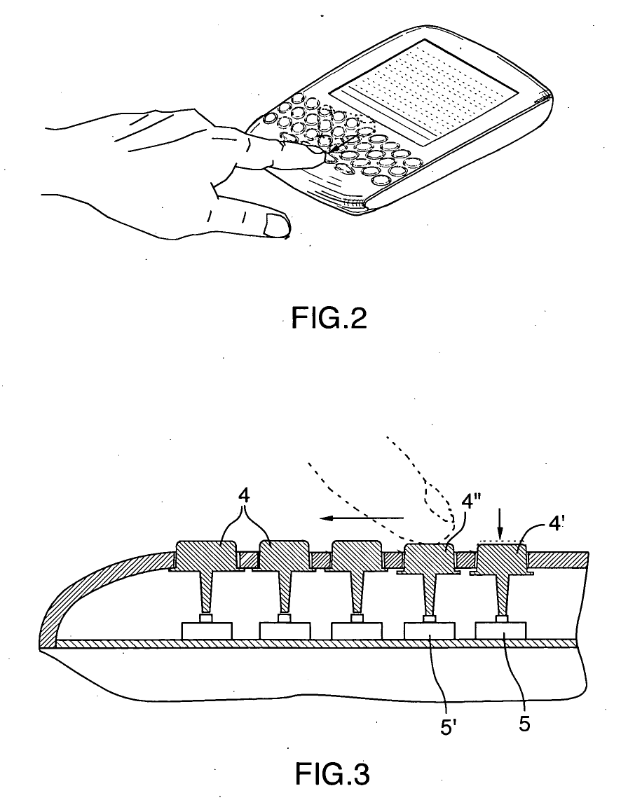

FIG. 2 simply illustrates a user dragging a finger “down” on the keypad, with the effect shown schematically in FIG. 3, where key 4′ has been subjected to a light touch to trigger two-stage switch 5, and where key 4″ is being subjected to a light touch to trigger two-stage switch 5′. Key 4′ is shown here as remaining depressed, for purposes of illustration, but of course it will in fact rebound to its normal position instead of remaining slightly depressed, as soon as the user's finger leaves it.

Advantageously, the edges of the keys may provide the user with greater tactile feedback than a touchpad, for example; the user can feel his or her finger dragging from key to key, whereas on a touchpad it is sometimes difficult to detect or measure one's own motion.

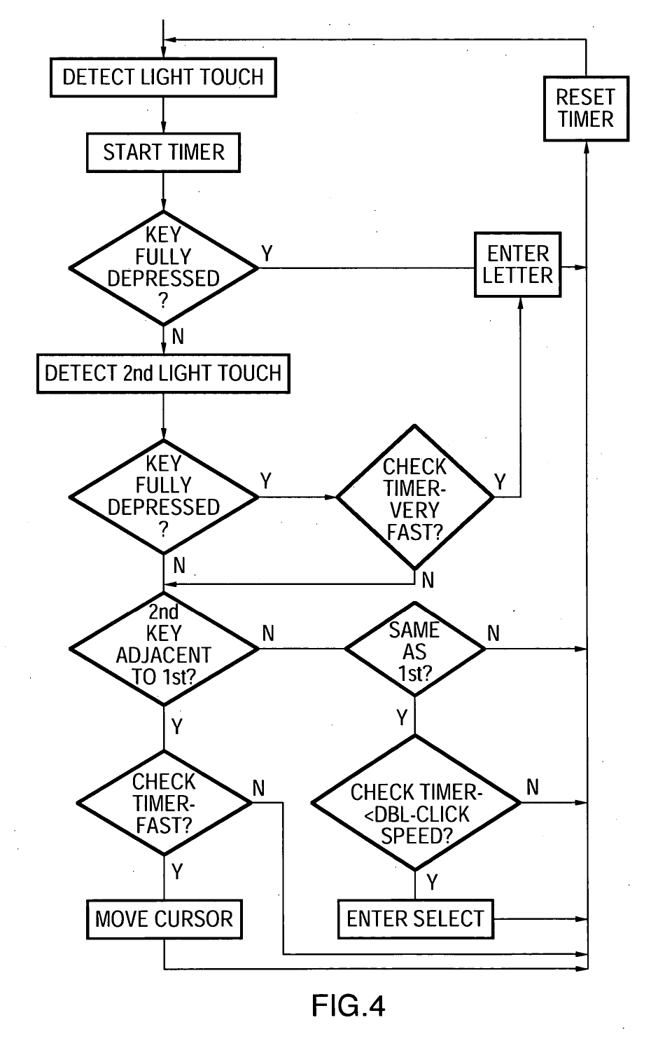

So that there is no confusion between random accidental light touches and intentional light touches of sequential keys, or to at least minimize such confusion, software embodied in the device applies certain logic, as illustrated in accompanying FIG. 4. That logic will be explained in the following.

As soon as a light touch of a key is detected, a timer is started. If a full depression of that key is the next event, the light touch is ignored, the letter or action indicated by the key is entered, and the timer is reset. If there is no full depression, and instead the next event is another light touch, then again the question is whether the second touch becomes a full depression or not. If so, unless slow, the letter or action indicated by the key is entered, and the timer is reset. (A slow, i.e. if the next light touch event is not nearly immediate, the user may not be trying to navigate, but instead may be simply moving from a rest location to the intended key, which might happen to be next to the rest location.) If not, i.e. if there have been two sequential light touches, then the question is whether the second key is adjacent to the first. If not, then unless it is the same key, the timer is reset. If it is the same key, and within a short time interval, then that may be treated as a “double-click”, or “select” action. If the second key is adjacent to the first key, then unless the time between touches is considered excessive, the cursor is moved in the direction indicated by the direction from the first key to the second key.

In other words, if fairly rapid consecutive light touches of adjacent keys are detected, neither one maturing to full depression of either key, that is interpreted as the user intending to indicate some desired navigation function. Typically, that would be to move the cursor left, right, up or down as the case may be. However, software could be used to interpret that differently, for example to scroll in a particular direction or move up or down one page or screen, or some other desired navigation function. Or, in conjuction with special “selection” keys such as a Shift key 6, Function key, Alt key or the like, a particular movement on the keys could have more than one possible function. A “down” movement might move down one line at a time normally, for example, but one page at a time if Shift key was depressed. Other similar applications could readily be programmed, of course.

If desired, fairly rapid consecutive light touches of the same key, neither one maturing to full depression of that key, could be interpreted as a double-click or given some other desired interpretation, and additional interpretations if in conjunction with a Shift key or the like.

In the preceding, the subsequent light touch is acted on only if, within a very small time interval such as 0.2 seconds that touch does not mature to full depression of the key. The timer also ensures that consecutive light touches are not considered to indicate a desired motion if those consecutive light touches are some relatively long time period apart, which could still be a relatively short interval like 2 seconds or less, or significantly longer if desired. Clearly, the specific time intervals for any of the actions are not critical, and could be varied as desired for the particular device and desired degree of sensitivity. It is possible also that the time intervals could be adjustable as a user preference, i.e. so that the user could set the desired sensitivity level for one or more of the time intervals.

Preferred and exemplary embodiments of this invention are described herein. Variations of those embodiments may become apparent to those of ordinary skill in the art upon reading the foregoing description. It is expected that skilled persons will employ such variations as appropriate, and it is expected that the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Without limiting the generality of the foregoing statement, some specific examples of possible variations may include the following, though others may be apparent to those knowledgeable in the field of the invention:

In some embodiments, cursor movement might be provided by detecting consecutive light touches of adjacent keys, but the double-click function by detecting consecutive light touches of the same key might be omitted, though less advantageous.

As previously mentioned, the various time intervals could be varied over a wide range depending on desired sensitivity, and could possibly be variable by the user, according to user preference.

All or most of the keys on the keypad could be involved, or if desired, just a central or other designated area could provide the desired motion detection.

The specific type of two-stage switch is not essential to the invention. Any suitable switch providing two-stage operation as described above could be employed, the selection of the specific switch being up to the product designer, with no inventiveness required in making that selection.

Further variations may be apparent or become apparent to those knowledgeable in the field of the invention, and are within the scope of the invention as defined by the claims which follow.

1. A keypad for an electronic device, said keypad having multiple keys wherein at least some of said keys are two-stage keys such that a light touch indicates one function and a full depression indicates another function, and wherein said device is programmed so that consecutive light touches of at least two adjacent keys indicates a desired navigation function.

2. The keypad of claim 1, wherein said desired navigation function is movement of a cursor on a display screen.

3. The keypad of claim 1, wherein said desired navigation function is scrolling of a display screen.

4. The keypad of claim 1, wherein said desired navigation function is a Page Up or Page Down movement of a display screen.

5. The keypad of claim 1, wherein said desired navigation function varies, depending on a user-operable selection key.

6. The keypad of claim 1, wherein said device is programmed so that consecutive light touches of the same two-stage key indicates another desired function.

7. In a handheld electronic device having a display screen and using a keypad as an input means, the keypad having multiple keys, the improvement wherein at least some of said keys are two-stage keys such that a light touch indicates one function and a full depression indicates another function, and wherein said device is programmed so that consecutive light touches of at least two adjacent keys indicates a desired navigation function on the display screen corresponding to a direction of said consecutive light touches.

8. The improvement of claim 7, wherein said desired navigation function is movement of a cursor on the display screen.

9. The improvement of claim 7, wherein said desired navigation function is scrolling of the display screen.

10. The improvement of claim 7, wherein said desired navigation function is a Page Up or Page Down movement of the display screen.

11. The improvement of claim 7, wherein said desired navigation function varies, depending on a user-operable selection key.

12. The improvement of claim 7, wherein said device is programmed so that consecutive light touches of the same two-stage key indicates another desired function.

13. A method of detecting a desired navigation movement on a display screen of a handheld electronic device, said device having a keypad with two-stage switches as keys on at least a portion of said keypad, said method comprising detecting consecutive light touches of first and second adjacent keys, neither one maturing to full depression of either key, and interpreting said detection as a desired navigation function on the display screen, corresponding to the direction of the first key to the second key.

14. A method as in claim 13, comprising the steps of:
detecting a first light touch and then starting a timer;
ignoring the light touch if a full depression of the key is the next event, and resetting the timer; and
otherwise if the next event is another light touch which does not mature to a full depression of the key, then if the second key is adjacent to the first, recognizing that as a desired navigation input, or otherwise resetting the timer.

15. A method as in claim 13, wherein consecutive light touches of the same two-stage key indicates another desired function.
